(19) United States
(12) Patent Application Publication
(10) Pub. No.: US 2017/0364984 A1
(43) Pub. Date: Dec. 21, 2017

(54) Cloud Based Ingredient Data Management

(71) Applicant: David Ward Hughes, Dallas, TX (US)

(72) Inventor: David Ward Hughes, Dallas, TX (US)

(21) Appl. No.: 15/187,782

(22) Filed: Jun. 21, 2016

(51) Int. Cl. G06Q 30/06; G06F 17/30; G06K 9/64; G06F 3/0484; G06K 19/06; G06K 9/78

(52) U.S. Cl. CPC G06Q 30/0623; G06K 19/06037; G06K 9/78; G06K 9/64; G06F 3/0484; G06F 17/30368; G06F 17/30339; G06F 17/30259; G06F 17/30879

(57) ABSTRACT

The improved data management system includes a computerized database device for capturing item technical data provided and maintained by a vendor. A digital representation of the item, for example, a linear or matrix code, ASCII, image, or video data is associated with the technical data. An end user interface utilizes a camera on the end user's smart phone, tablet device, or other computing device to generate image related data of an item of interest for correlation with the digital representation, and is utilized by the database to look up and present the technical data associated with the item of interest. An enhancer interface allows the addition and maintenance of enhancement data to be associated with item technical data and presented to an end user when considering an item of interest.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates to computerized database systems for providing management of and access to content relevant to food ingredient samples.

### Description of Related Art Including Information Disclosed Under 37 CFR 1.97 AND 1.98

Food ingredient manufacturers commonly provide samples and technical documentation to end users of their food ingredient products for use in developing formulas and finished products. Persons utilizing the ingredient samples and technical documentation in the development of finished products include food scientists, research chefs, lab technicians, regulatory, and quality control personnel. These end users are typically developing a formula with multiple ingredients. Due to the amount of technical information required to accompany each product sample, there is not enough space to include on the sample label. Consequently, that additional, voluminous information, of up to twelve pages per sample or more, must either be printed on paper and shipped along with the sample, or must be emailed or otherwise provided to the end user. Often, this end user misplaces or loses the printed material and must contact the supplier, delaying the project. End users also tend to forget to save the files related to the ingredient sample, and must contact the supplier for technical documents, which also costs valuable time.

This technical documentation is important to any person utilizing the ingredient sample and technical documentation in the development of a finished product, such as food scientist, research chef, lab technician, regulatory, and/or quality control personnel, because it is vital for each to know critical aspects of the ingredient and how the ingredient will impact the finished product. This information includes, but is not limited to: Specification Sheets; Nutritional Information; MSDS/SDS; Allergen Statement; COA; COO; Kosher Certificate; Halal Certificate; GMO Free Certificate or Statement; Gluten Free Certificate or Statement; Organic Certificate; Natural Statement; PHO Free Statement. Common methods and solutions simply do not ensure that end users have the most accurate, up to date product ingredient information available, when needed. What is needed is a solution that gives an end user access to the information they need, when wanted, where wanted, and that makes the end user more productive and efficient in completing projects. Moreover, a solution is needed that enhances the experience the end user has with the ingredient, brand, and company; that is environmentally friendly (reduces the need to provide printed documentation); and that is on trend, leveraging the way people are utilizing their mobile devices. The invention presented herein satisfies this need and provides other benefits as disclosed in detail below.

### BRIEF SUMMARY OF THE INVENTION

The present invention is presented in multiple embodiments, and is drawn in a first embodiment to a cloud based system for managing ingredient data, the system comprising: a network-accessible database device adapted to accept from a vendor through a vendor interface and retain within the database device at least one digital representation and a plurality of technical data for each of a plurality of items, the database device further adapted to accept from an end user through an end user interface an image related data for correlation with one of the at least one digital representations and present to the end user the technical data related to the correlated item; and an image processor operable within the end user interface for converting a digital image data to the image related data for correlation with the at least one digital representation.

Additional embodiments present the system further comprising: a vendor interface for a vendor computing device, the vendor interface adapted to access a computing device camera to obtain an image for use in generating the digital representation; and/or an end user interface for an end user computing device, the end user interface adapted to utilize the image processor to access a computing device camera to obtain a digital image data for use in generating the image related data.

Still other embodiments present the system wherein the database device is further adapted to accept enhancement data for each of the plurality of items, the system further comprising: an enhancer interface for an enhancer computing device, the enhancer interface adapted to submit enhancement data for one or more of the plurality of items; wherein the database device is further adapted to manage the digital representation and technical data stored therein through commands received from a vendor interface; wherein the database device is further adapted to accept from an enhancer interface and retain within the database device a plurality of enhancement data for one or more of the plurality of items; and wherein the digital representation is chosen from the group consisting of linear code data, matrix code data, textual data, and image data.

In yet other embodiments the system is presented wherein the image related data is generated based upon the action of a camera device; wherein the database device is further adapted to track an update to an item or to the technical data associated with an item and to provide notification of the update to an end user that registered a previous interest in the item or the technical data associated with the item; wherein the database device is further adapted to capture transactional data based on system use; wherein the database device is further adapted to capture transactional data based on system use and to generate a configurable report based on the captured transactional data; wherein the database device is further adapted to generate a linear code or matrix code for use with an item; wherein the database device is further adapted to correlate the image related data with one digital representation, and to present to an end user the related technical data; and wherein the database device is further adapted to correlate the image related data with more than one digital representation, and to present to the end user the related technical data.

The present invention is also presented in an embodiment drawn to a cloud based method for managing ingredient data, the method steps comprising: accepting from a vendor through a vendor interface, for retention within one or more database device tables, a plurality of technical data and at least one digital representation and for each of a plurality of items and retaining same within one or more database device tables for subsequent database operations thereon; accepting from an end user through an end user interface an image related data representing an item of interest; and correlating the image related data with a digital representation to determine the item of interest, and retrieving the related technical data from the database device for presentation of the technical data to the end user.

Another embodiment presents the method steps further comprising: accepting an image from a vendor user computing device camera; and generating the digital representation. In another embodiment the method steps further comprise: accepting an image from an end user computing device camera; and generating the image related data. Another embodiment presents the method steps further comprising: accepting from an enhancer user through an enhancer interface, for retention within the database device tables, enhancement data related to one or more items. Another embodiment presents the method steps of above, wherein the digital representation is chosen from the group consisting of linear code data, matrix code data, textual data, and image data; and wherein the image related data is generated based upon the action of a camera device.

Another embodiment presents the method steps further comprising: tracking an update to the item or the technical data associated with the item; and providing notification of the update to an end user that registered a previous interest in the technical data or the related item. Yet another presents the method steps further comprising: capturing transactional data based on system use; and generating a configurable use report based upon the captured transactional data. Another embodiment presents the method steps further comprising: generating a linear code or matrix code for use with an item. Yet another embodiment presents the method steps further comprising: correlating the image related data with one or more digital representations; and presenting to the end user the related technical data.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 depicts a first embodiment of a system and its components for providing cloud based ingredient data management;

FIG. 2 is a flow diagram depicting major functional behavior with regard to the vendor interface of the embodiment;

FIG. 3 is a flow diagram depicting major functional behavior with regard to the end user interface of the embodiment;

FIG. 4 is a flow diagram depicting major functional behavior with regard to the enhancer interface of the embodiment;

FIG. 5 is a flow diagram depicting major functional behavior with regard to the image related data correlation functionality of the embodiment;

FIG. 6 is a depiction of an embodiment of the system user interface presenting the user account details page;

FIG. 7 is a depiction of an embodiment of the system user interface presenting the ingredient search results page;

FIG. 8 is a depiction of an embodiment of the system user interface presenting the ingredient details page;

FIG. 9 is a depiction of an embodiment of the system user interface presenting the sample request page;

FIG. 10 is a depiction of an embodiment of the system user interface presenting the ingredient details page for entry and modification of ingredient data;

FIG. 11 is a depiction of an embodiment of an embodiment of the system digital representation of an ingredient data stored within the system database; and

FIG. 12 is a depiction of an embodiment of the system user interface presenting ingredient data lookup results for an end user.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

As used herein, “cloud” or “cloud based” means computing applications, services, or resources that are available to users on demand via the Internet from a computing provider server or servers. This includes servers provided and managed by known dedicated cloud computing providers and proprietary computing providers. Access to these servers may be by wired networking connections (for example, Ethernet or the like) or by wireless networking connections (for example, Wi-Fi or cellular provider networks for accessing the Internet). As used herein, “computer readable medium” means any tangible portable or fixed RAM or ROM device, such as portable flash memory, a CDROM, a DVDROM, embedded RAM or ROM integrated circuit devices, or the like.

As used herein, “Specification Sheet” means a document describing a food ingredient, its uses, and its characteristics both chemical and physical, and includes the ingredient statement of the material. As used herein, “Nutritional Information” means the detailed nutritional profile of a food ingredient. As used herein, “MSDS/SDS” or “Material Safety Data Sheet/Safety Data Sheet” means a document that provides comprehensive information about a substance or mixture for use in a workplace or laboratory and are used as a source of information about hazards, including environmental hazards, and to obtain advice on safety precautions. The document describes any special precautions that should be taken should a food ingredient come into contact with the skin, or eyes, or be inhaled or ingested; describes recommended treatments for such; communicates whether product is flammable and if there is a known flashpoint, and how material is best extinguished; and recommends storage and handling conditions, and how to handle an accidental release. As used herein, “Allergen Statement” means details of known allergens in a food ingredient and whether the ingredient is processed in a facility with known allergens.

As used herein, “COA” or “Certificate of Analysis” means a certificate confirming a specific lot number of a food ingredient that has been tested and meets pre-determined parameters, chemical and/or physical. As used herein, “COO” or “Country of Origin” means a statement of the country of origin of a food ingredient. As used herein, “Kosher Certificate” means a certification document provided by an approved rabbinical association confirming the ingredient is produced according to kosher requirements. As used herein, “Halal Certificate” means a certification document provided by an approved Islamic association confirming the ingredient is produced according to halal requirements. As used herein, “GMO Free” means a certification document confirming that the ingredient does not contain material that has been genetically modified. As used herein, “Gluten Free” means a certification document confirming that the ingredient does not contain gluten. As used herein, “Organic” means a certification document from a recognized independent agency, or a statement from the producer (or vendor) confirming the ingredient meets organic requirements. As used herein, “Natural” means a statement from manufacturer that the ingredient is considered natural and with essentially no artificial components. As used herein, “PHO Free” means a statement from manufacturer that the ingredient does not contain partially hydrogenated oil.

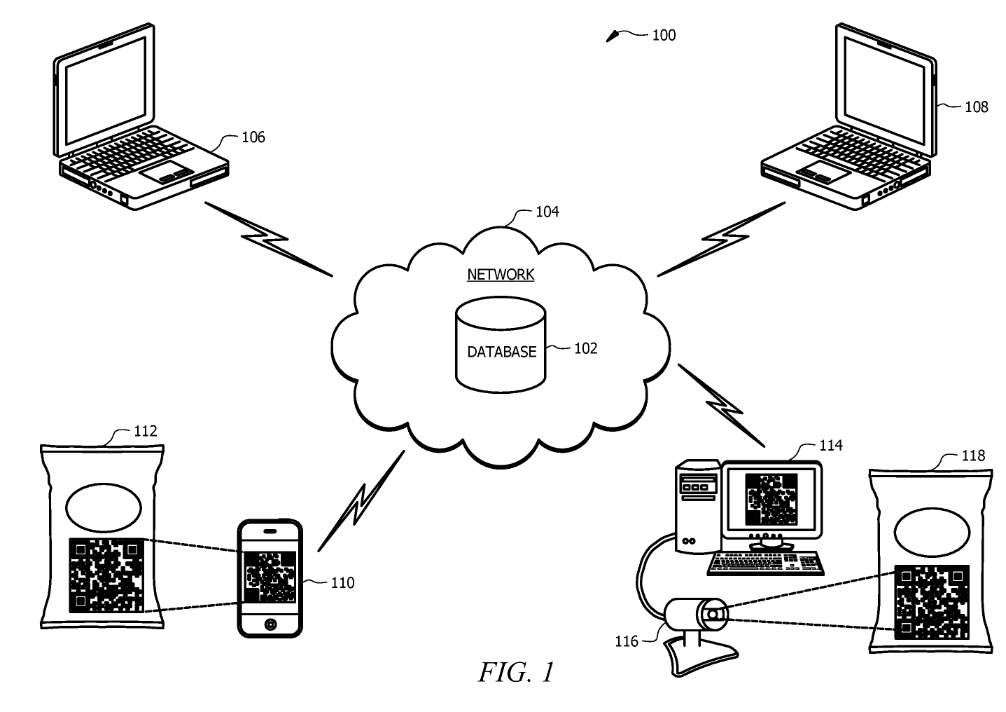

FIG. 1 depicts a first embodiment of a system for providing cloud based ingredient data management. In this embodiment of the invention (100), a network-accessible computerized database device is utilized for data storage and retrieval, and runs upon a general purpose computing platform. A standard structured query language (SQL) relational database management system (RDBMS) is leveraged to provide storage and access to, and manipulation of, the ingredient and user data stored within the database in table format (102). The computing platform upon which the database operates is a standard server computing platform, which may be configured as a single or multiple server for redundancy and reliability purposes. The SQL RDBMS (102) may operate thereon as a single database or as a cluster for redundancy and reliability purposes. Special purpose SQL scripts are utilized to program and structure the database device to perform the specialized functions described herein. Programming of the database devices to achieve the specialized and inventive functionality specified herein is performed using common scripting techniques suitable for the type of RDBMS chosen. Choice and configuration of the type and number of computing platforms and RDBMS is within the skill of one of ordinary skill and need not be described herein.

The database device (102) may be accessed by a plurality of end user computing devices (106, 108, 110, and 114), including mobile devices, for example, smart phones (iPhone, Android, Microsoft, and the like), tablet devices (IPad, Surface, and the like), laptop PCs, and/or desktop PCs, over a network (104) that is wired or wireless. In a cloud or Internet networked system each database may reside in a data center at a location remote from one another, with the interconnection among data centers and other end user computing devices being comprised of standard wired lines (for example, copper or optical) or wireless (for example, packetized cellular or other radio relay transmission means) or some combination thereof Standard TCP/IP packetized communications protocols ultimately control the flow of data among these computing devices. Computing device access to each of the networking means is effected by the standard protocols required by the type of network. For example, an end user smartphone device accessing the network may do so over a standard Wi-Fi network or over a cellular communications network utilizing a standardized communications protocol for data packet transfer.

For wide adoption of the system it is intended that end users computing devices are general purpose computing devices that support operation of the specialized end user interface. For example, end user computing devices include portable standard smartphones, laptops, tablets, notebooks, web enabled watches, and the like, and non-portable desktop computers and the like. Such computing devices typically support standardized web browser applications through which the end user interface may be provided. For example, a standard web browser is capable of executing and displaying web pages written in one or more of JavaScript, Java, Python, CSS, PHP, Ruby, C++/C/C#/Objective-C, Perl, and the like, which affords creation of specialized interfaces that support user input and output to the networked system. Such programming languages are commonly used and well understood for the creation of specialized programs and interfaces. Because each has strengths and weaknesses for given applications, selection of the type of programming language for a particular use is within the skill of one of ordinary skill. The inventive functionality may also be achieved through dedicated program applications that operate on a computing device to present the end user interface. These dedicated program applications (or “apps”) are platform specific, and can be developed using common software development tools for the given platform. For example, to develop an app for use on a common Apple® iOS operating system product the Swift programming language may be utilized. Choice and use of development tools for a given computing device platform is likewise within the skill of one of ordinary skill.

Moreover, these end user computing devices (110 and 114) also support camera hardware functionality, which allows the device to capture digital images for subsequent processing. If the camera functionality is not integral to a particular computing device, a peripheral camera (116) may also be utilized. For example, high definition camera devices are readily available that plug into a USB or other such port on a desktop computer. Access to the camera hardware on a computing device may be achieved through the operating system application programming interface (API) by development of specialized image processor software code that utilizes API calls to access the hardware, or by direct access to the hardware using low level programming language function calls (for example, using the C programming language, scripting language, or other, or some combination thereof).

Users of the innovative system include at least a vendor user and an end user, and an optional enhancer user, each with specialized roles and with common roles. The innovative system in this present embodiment focuses on the management of food ingredient data that is created and maintained by the vendor; maintained and presented for sale by the vendor; enhanced through the addition of marketing and advertisement data by the enhancer, and sold to and utilized by the end user.

The database device (102) is adapted to accept from a vendor through a vendor device (106) interface and retain within the database device at least one digital representation and a plurality of associated technical data for each of a plurality of food ingredient items. The database device (102) is further adapted to accept from an end user (110 or 114) through an end user interface an image related to data for a food ingredient package (112 and 118, respectively) for correlation with one of the digital representations in the database, and present to the user the technical data related to the correlated item. In this manner the end user may efficiently perform lookups of ingredient data, maintain a library of favored ingredient data, monitor ingredient technical data for changes, receive enhanced information associated with ingredient data, and order additional ingredient samples. The end user may also request a quote, request a contact from the vendor, access promotional information (prototype recipes using a particular ingredient), and/or deliver information via video format.

In the present embodiment the digital representation is a QR Code, which is a common matrix code that is capable of encoding large amounts of data in a two dimensional image. In another embodiment the system also utilizes standard linear bar code representations. In another embodiment the digital representation is an optical character recognition (OCR) scan of a food ingredient package label to capture ASCII characters present on the label. In another embodiment the digital representation includes a thumbnail image of the food ingredient package, package label, and/or package ingredients for display on the food ingredient detail page and search results page. Image data may utilize polygon determination and normalized shading, color, and/or hue data for the given package. Once digitized, such image data is easily stored as image data digital representation. In yet another embodiment the digital representation is some combination of the above.

In an example of system use a vendor of food ingredients utilizes a computing device (106) to access the vendor interface to input to the database (102) food ingredient package data and associated additional data. The database (102) accepts the ingredient package data and associated additional data that was input and generates a unique digital representation of the food ingredient. This digital representation includes textual and/or numeric data that is unique to the stored ingredient data, and affords efficient access to the totality of the ingredient package data and associated additional data. In another embodiment the digital representation includes image and/or video data that is unique to the stored ingredient data.

An enhancer user utilizes a computing device (108) to access the enhancer interface of the system to enhance the available ingredient package data. Upon login the enhancer performs a keyword or vendor search for available ingredients, and may subsequently associate advertising content with one or more of the available ingredients. This associated advertising content may be in the form of additional digital images or files that are presented directly to an end user in response to an ingredient search, or may be in the form of standard ad-serving links as commonly utilized with online content.

The end user utilizes a smartphone device (110) to image a QR Code on a food ingredient package (112). The computer software application running on the smartphone accesses the camera to obtain a lighted image of the QR Code. The contrasting light and dark areas of the QR Code contain encoded data representative of the imaged package (112), which is decoded by the smartphone device and presented to the database device (102) via the wireless network as image related data. The process for decoding a QR Code in the user's interface is well understood, and involves an initial determination of the QR Code version and format marker. The version information informs the system of the physical size of the QR Code (i.e., number of pixels or modules). The format marker informs the system of the error correction level and the size and type of data mask to be applied to the QR Code data. With the data mask applied the system may then discover the QR Code data area, which consists of the header and data chunks. Header data informs the system of the encoding type and length of data bits. The data bits are then read and converted to ASCII characters, which are compared with the unique digital representation to complete the ingredient lookup.

The database device (102) subsequently correlates the image related data with the stored ingredient data digital representations by performing a lookup query, and returns to the end user the lookup query results. The end user then has the option to view a particular ingredient listed in the query results and access the associated data. Enhanced data associated with a particular query result is also presented to the end user.

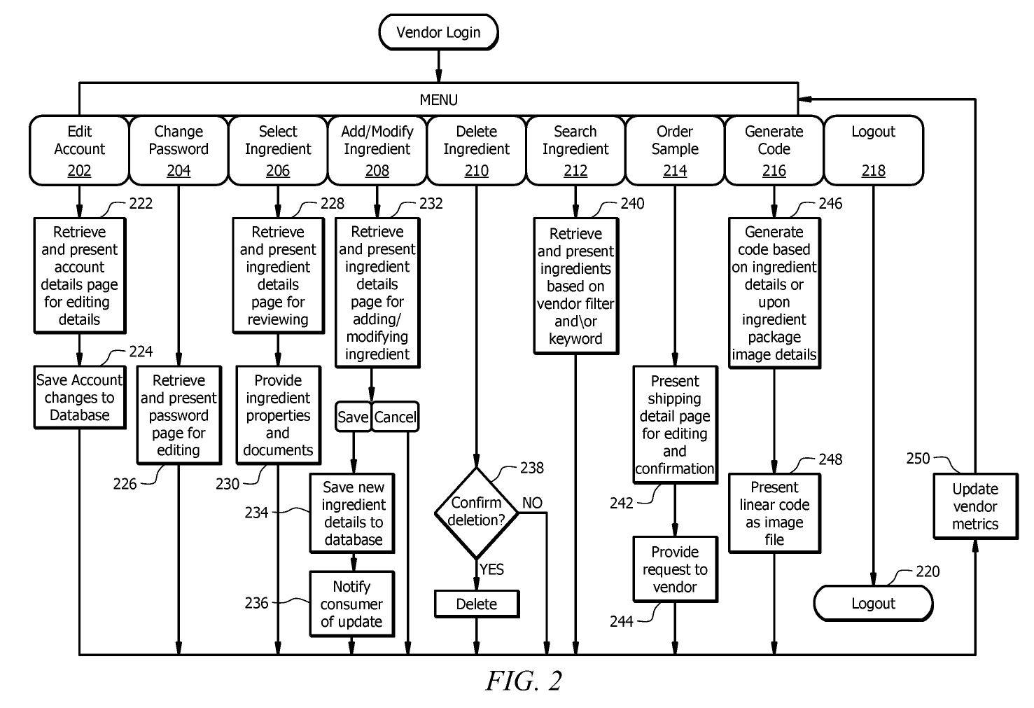

FIG. 2 is a flow diagram depicting major functional behavior with regard to the vendor interface of the embodiment. Full access to the system requires that the vendor register, for free or for a fee, to obtain a password controlled account. The vendor, upon accessing the system, is presented with the interface implemented through a standard web browser running upon the vendor's computing platform. The interface presents menu options for the vendor including the ability to edit the vendor's account (202), change the vendor's password (204), select specific ingredient data stored within the database (206), add or modify ingredient data (208), delete ingredient data (210), search through stored ingredient data (212), order samples of ingredient data (214), generate the digital representation code (216), and logout (218) to logout of the interface (220).

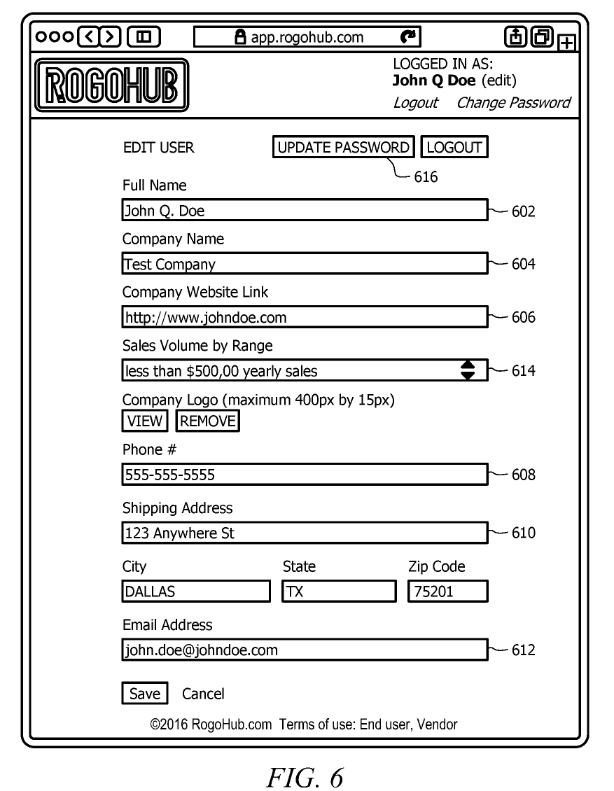

As implied, the vendor user may edit the vendor account (202). Upon selection of this menu item the vendor user information is retrieved and is presented on an account details page for editing (222). FIG. 6 is a depiction of an embodiment of the system user interface presenting the user account details page. As shown the system maintains within the database basic vendor user information including user name (602), company name (604), company website URL (606), phone number (608), shipping address (610), and email address (612). Additional demographic information, including vendor sales volume (614), is also retained for statistical and administrative (billing) use. The vendor password may also be updated from this page (616). Turning once more to FIG. 2, if a password change is requested the vendor is presented with a password page for editing (226). Once vendor account data updates are entered, the updated data is saved to the system database (224).

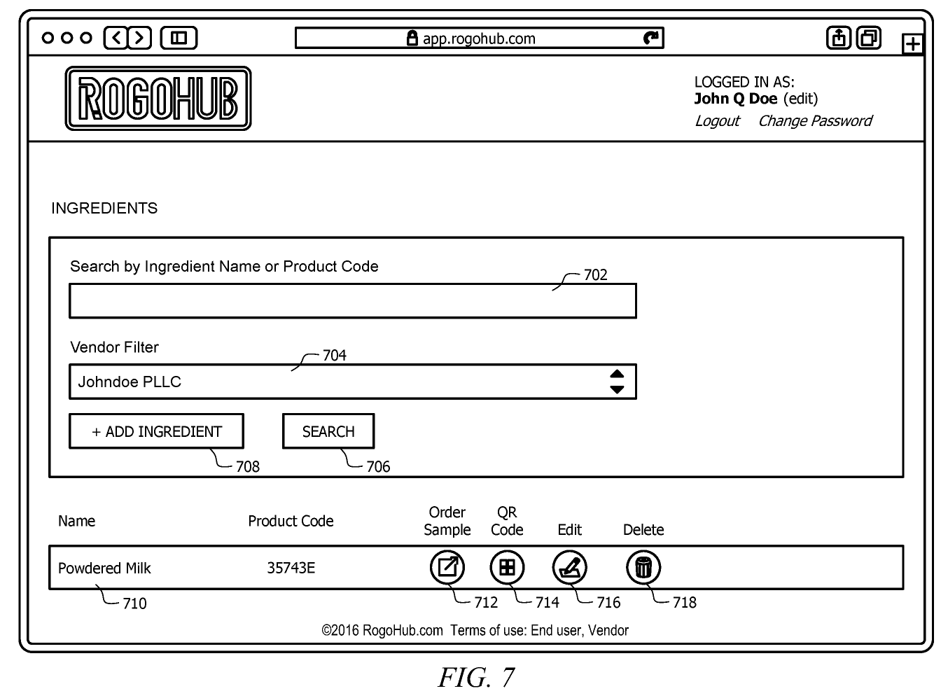

Database ingredient search (212) results in the retrieval and presentation of ingredients based upon the vendor filter and/or ingredient keyword (240). FIG. 7 is a depiction of an embodiment of the system user interface presenting the ingredient search results page. As shown, the vendor or end user is presented with the option of providing a keyword (702) and/or vendor filter (704) to narrow the search. The vendor filter (704) is a dropdown box that is populated with all vendors registered with the system. Upon search (706) the relevant ingredient data is returned in row/column format for subsequent use. The name of the ingredient (710) is provided, along with the unique product code specified by the vendor. The name (710) is a hyperlink that affords selection of the ingredient data (206). The vendor is also given the option of ordering a sample (712), obtaining the QR Code image (714), editing the ingredient (716), or deleting the ingredient (718).

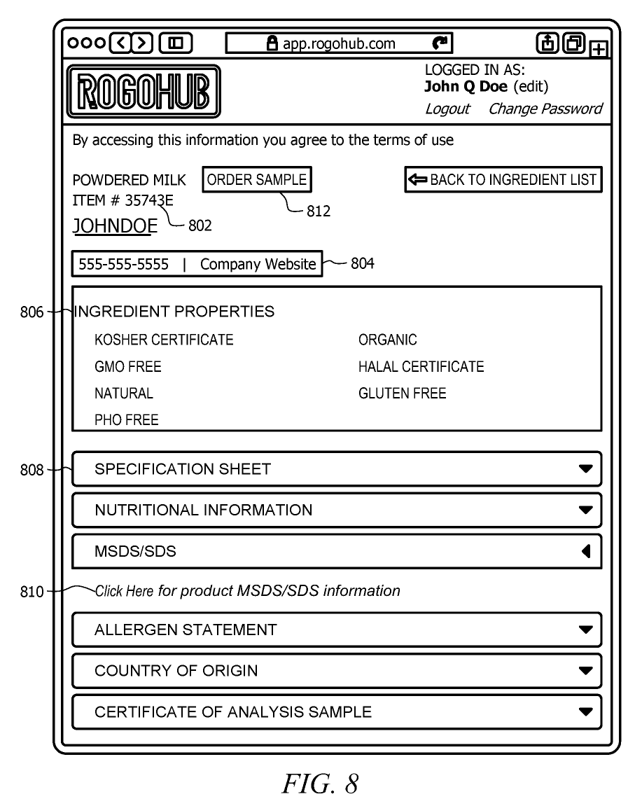

Upon selection of an ingredient hyperlink (710), the ingredient detail page is presented for review (228). The ingredient detail page presents the ingredient properties and associated data (230). FIG. 8 is a depiction of an embodiment of the system user interface presenting the ingredient details page. Visible on the page are the ingredient name and product code (802), and company information (804). Detailed ingredient properties are presented (806) as a checklist, including Kosher, GMO, Natural, PHO, Organic, Halal, and Gluten status for the ingredient. Associated data in the form of uploaded associated data files (808) are also selectable and downloadable (810) from this page. A sample of this ingredient (812) may also be requested from this page.

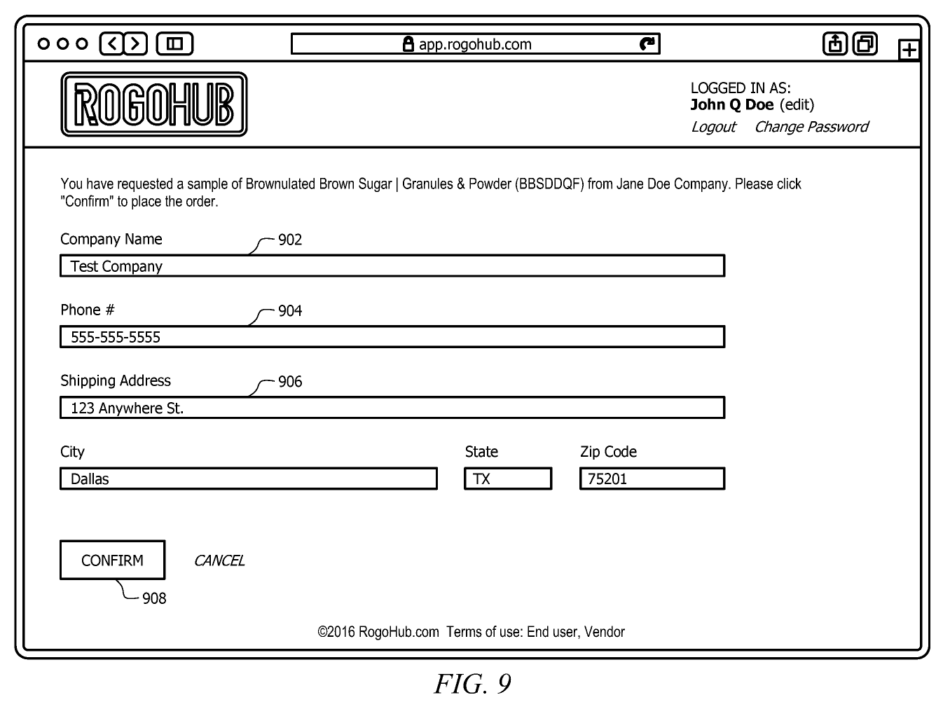

Requesting a sample (214) of an ingredient causes the system to present a shipping detail page to the user (242). FIG. 9 is a depiction of an embodiment of the system user interface presenting the sample request page. Only end users who have registered with the service are able to request a sample. Visible on this page is the requestor's company name (902), phone number (904), and shipping address (906), which will be associated with the sample request. This information is initially populated with the end user's saved information, but may be edited as necessary. Upon confirmation (908), the request is provided to the specific vendor (244) associated with the actual ingredient sample being requested (i.e., the vendor that added the ingredient to the database).

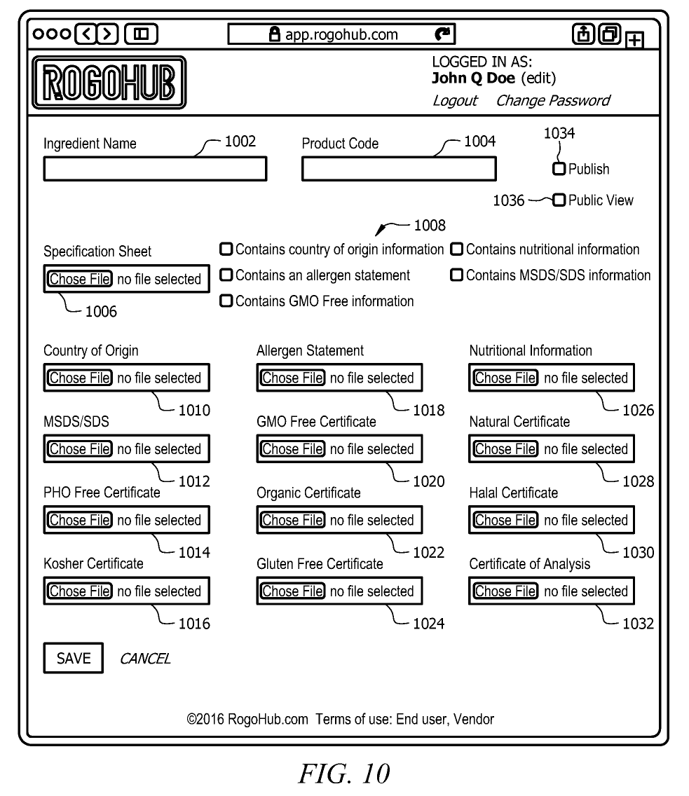

Addition of a new or modification of an existing ingredient (208) data causes the system to retrieve and/or present the ingredient details page for adding or modifying the ingredient (232). FIG. 10 is a depiction of an embodiment of the system user interface presenting the ingredient details page for entry of ingredient data. Visible on this page are form fields for entry/modification of the ingredient name (1002) and product code (1004) as well as Publish and Public View checkboxes. These checkbox options allow a vendor to suspend data (without permanently deleting), and/or make data “private” or viewable only to an end user who receives a sample with a service enabled label. Consequently, the data would not be viewable by performing a “Search.” Search terms may also be provided, for example, to provide keywords and terms for use by the search indexing utility to influence the search results during ingredient look up.

A product specification sheet may also be associated and subsequently uploaded (1006). Ingredient properties (1008) may be selected and additional associated data may be uploaded as necessary. The additional associated data includes a country of origin certificate (1010), material safety data sheet/safety data sheet (1012), PHO certificate (1014), Kosher certificate (1016), allergen statement (1018), GMO certificate or statement (1020), organic status certificate or statement (1022), gluten free certificate (1024), nutrition information (1026), natural certification or statement (1028), Halal certification (1030), and certificate of analysis (1032). Additional certifications or other related documentation are envisioned and may be added and are within the scope of the claims. Such documents are chosen and upon selection of the “save” option the documents are uploaded from the vendor computing device and are saved to the system database along with the additional ingredient details (234) as a hyperlink to the saved data. End users that have accessed the saved ingredient or have recorded an interest in the saved ingredient are notified of any document or information updates to the ingredient data (236). Ingredient data may also be deleted by a vendor (210). Confirmation of the intended deletion is first provided (238) before actual removal from the database occurs.

In another embodiment the user may enter regional specific associated data that is automatically selected for presentation to an end user based upon the end user's interface browser information. For example, the end user's interface browser typically provides an indication of the geographic region in which the end user is located. In this embodiment the system would then return the associated ingredient technical data to the user for the appropriate region (for example, English documents to a United States of America end user or German documents to a German end user).

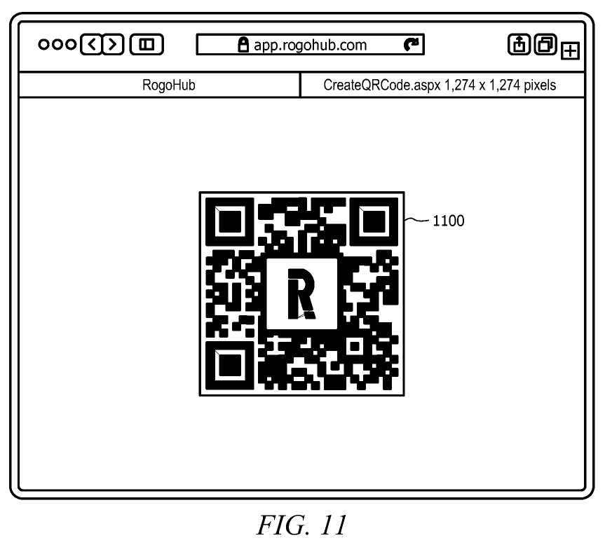

Selection of the QR Code hyperlink on the ingredient list screen (714) causes the system to generate a unique digital representation in the form of a QR Code in the present embodiment (216). This code is generated based on unique ingredient details or upon ingredient package details (246). More specifically, the system generates a unique identification code (in ASCII format—ASCII stands for American Standard Code for Information Interchange) associated with a specific Vendor/Product-code combination “instance” and it stores it in the database as a permanent record pointer. The system then generates, on-demand, a graphic with the imbedded encoded components that represent such ID as a standard QR Code. FIG. 11 is a depiction of an embodiment of the system digital representation of an ingredient data stored within the system database. Shown is the matrix code (QR Code). In another embodiment the system generates a linear bar code.

The system monitors vendor user actions and maintains vendor metrics that are stored within the database (250). These metrics provide valuable feedback regarding how each vendor utilizes the system. For example, the system monitors and stores information regarding the number of ingredients each vendor maintains, the types of ingredients maintained, frequency of system access, popularity of ingredients among end users, freshness of ingredient data, amount of ingredient data, and the like. Other intelligence captured with the metrics include, but is not limited to, who is looking at the vendor user's information, what ingredients are being viewed and requested, what ingredient data documents are being viewed or downloaded, who is scanning a digital representation, what is being scanned, and when it is being scanned. Upon logout (218) the vendor is logged out of the account (220).

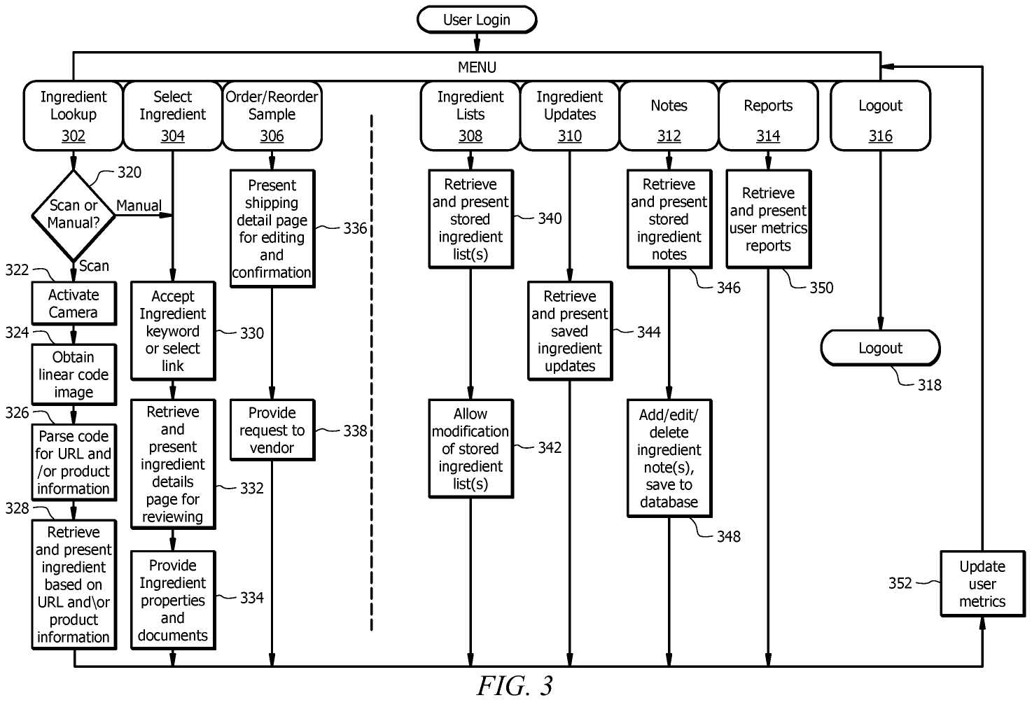

FIG. 3 is a flow diagram depicting major functional behavior with regard to the end user interface of the embodiment. Although an end user may perform a unique digital representation lookup of an ingredient data, full access to the system requires that the end user register and obtain a password controlled account to obtain product samples and utilize full system functionality. The end user, upon accessing the system, is presented with the interface implemented through a standard web browser running upon the end users computing platform. The interface presents menu options for the end user including the ability to lookup an ingredient or ingredients (302), select a particular ingredient (304), order or reorder ingredient samples (306), maintain ingredient lists (308), obtain ingredient updates (310), create and maintain notes regarding specific ingredients (312), obtain account reports (314), and logout of the system (316).

When performing an ingredient lookup (302), the end user may use automatic (scan) or manual methods (320). An automatic (scan) lookup is appropriate if the end user has possession of an ingredient package with a digital representation (i.e., QR Code) thereon. Otherwise, the end user performs a manual lookup. If automatic (scan) is chosen, the interface application activates the end user's computing device camera (322) to obtain an image of an ingredient package (324). A decoder device on the computing device decodes the image to obtain image related data in the form of a uniform resource locator (URL) link (326) to ultimately obtain the product information from the system database (328). The system database is queried to correlate the image related data with the stored digital representation, and the end user is presented with the stored ingredient data screen as depicted in FIG. 8, which is discussed above.

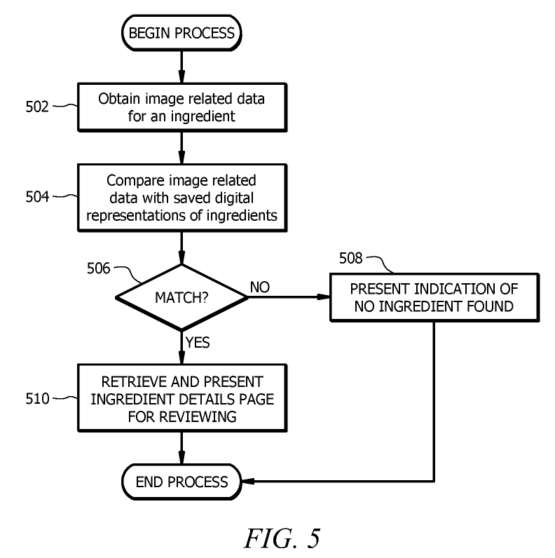

FIG. 5 is a flow diagram depicting major functional behavior with regard to the image related data correlation functionality of the embodiment. Once the end user camera device obtains the image related data for an ingredient (502), the image related data is forwarded over the network connection to the system database where the image related data is automatically compared with saved digital representations of stored ingredient data (504). In the present embodiment this involves comparison of such information as ingredient data table index values and table field data. If a match is found (506), the ingredient detail is read from the database tables and presented to the end user on an ingredient details page for reviewing (510). If, however, no match is found (506), the end user is presented with an indication of such (508). Additional logic within the system database may rank the ingredient data with regard to closeness of match to the ingredient data sought and may return the ranked ingredient data as an alternative. In another embodiment the system may return compatible other ingredients commonly requested with the ingredient data sought.

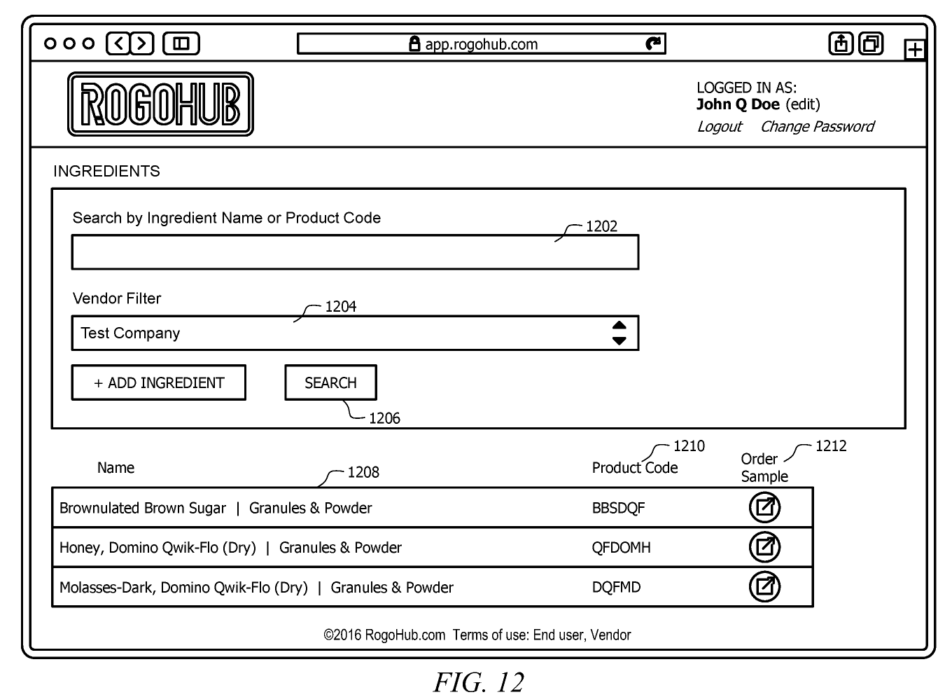

Referring once again to FIG. 3, during a manual lookup the end user is presented with an interface page capable of accepting a keyword or vendor filter search (330). FIG. 12 is a depiction of an embodiment of the system user interface ingredient search page presenting ingredient data lookup results for an end user. Visible on this page is a form field for entering the keyword upon which the search is performed (1202) and/or a vendor filter dropdown (1204) for further structuring the search (1206). In other embodiments the search parameters may be expanded to include other categories and keywords. Once the search is performed, the relevant ingredients are retrieved from the database (332) and a listing of the search results is presented (1208) in row/column format. Each result presents the ingredient name as a hyperlink to the ingredient page detail, with the ingredient's unique product code (1210). Selecting an ingredient name hyperlink (1208) causes the system to display on the user interface the ingredient data as depicted in FIG. 8. Ingredient properties and documents are available from this screen (334). Samples of the particular ingredient may be ordered by selecting the order sample hyperlink (1212). Selection of the sample hyperlink presents to the user the sample request shipping detail page depicted in FIG. 9 and discussed above. The end user is presented with the shipping detail for confirmation (336) before the request is provided to the vendor (338). In another embodiment the user provides shipping account information during registration that is sufficient to effect the automatic shipment of the requested sample upon selection.

Ingredient lists (308) prepared by the end user are stored and maintained in the system database for subsequent retrieval (340). For example, the end user may create ingredient lists that represent particular recipes with the preferred ingredients and/or vendor sources for the ingredients. Such lists may be modified at will (342), and become a part of the end user metrics (352) maintained by the system. Further, each time an end user scans a QR Code of a service enabled label, the service will collect information regarding that event, not limited to, but including: date, time, location, end user name, end user mobile phone number, end users company, end user address, end users email address, item name, and item number. This end user metric information is of interest to the vendor who provided the sample, as they will now know much more about what is happening with the samples provided to end users. Vendor users may monitor such metrics to determine popularity of particular ingredients and particular end user's opinions regarding same. Notes for each ingredient (312) may also be added to the system (348) for subsequent retrieval (346) by the end user. The addition of notes may allow an end user with a shared account to communicate preferences to those with which the end user shares access, and may assist the end user in remembering usage details over a period of time. Reports may be generated (314) by the end user, presenting saved usage metrics and other helpful system usage details (350). Ingredient updates provided by a vendor are presented to the end user upon system access (344) to ensure that the end user has up-to-date information regarding ingredients of interest.

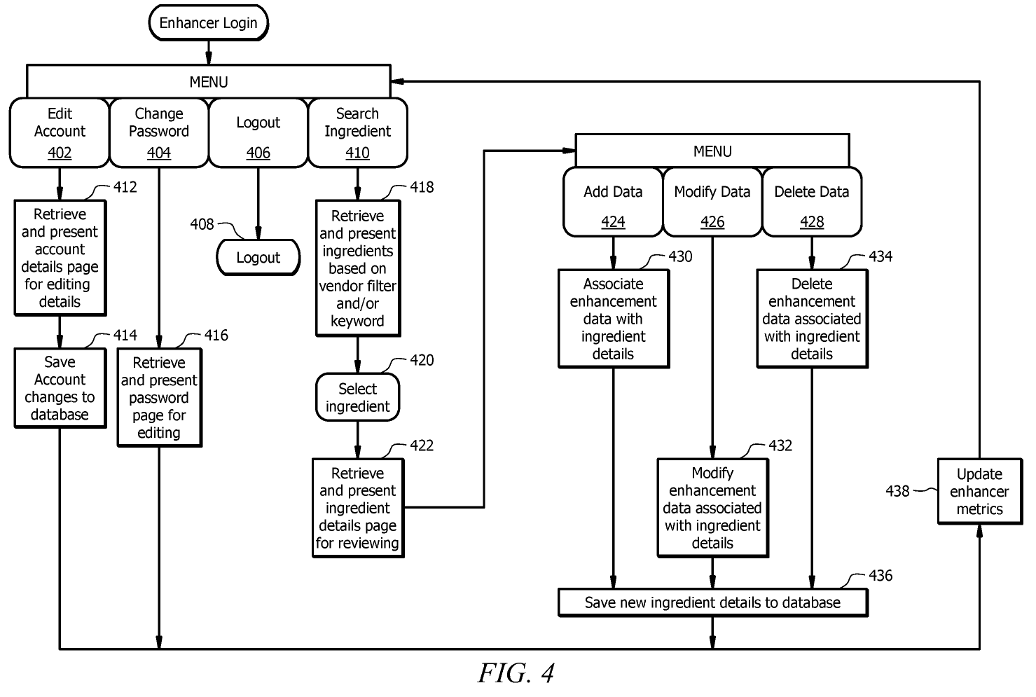

FIG. 4 is a flow diagram depicting major functional behavior with regard to the enhancer user interface of the embodiment. Upon login to the system the enhancer user is presented with an interface that allows editing the user account details (402), changing the password (404), searching an ingredient (410), and logging out (406). As with the vendor and end user accounts, the enhancer must also register. Consequently, the account information may be maintained by accessing the account details page for editing (412). Changes are saved to the database (414). The enhancer user password may also be retrieved, edited, and saved in like manner (416). Upon logging out (408), the interface is closed.

To add enhancement data to an ingredient, it is first necessary for the enhancer user to search for the ingredient or ingredients of interest (410). When conducting a search, the enhancer user is presented with the search interface as depicted in FIG. 7 and described above. The enhancer inputs keywords and/or a vendor filter (418) and selects an ingredient (420), causing the ingredient details page to be displayed on the enhancer interface (422). The enhancer user may then add data to an ingredient (424), modify existing data associated with an ingredient (426), or delete associated data (428). Adding data allows the enhancer to upload content or a link to content to be displayed to the vendor or end user when accessing the ingredient details (430). As the name implies, modifying data allows the enhancer to modify the content or link to content associated with the ingredient details (432), and delete data allows the enhancer to delete the associated data (434). Associated enhancement data may also include audio, audiovisual, and/or textual data. Additions, modifications, and deletions are saved to the database (436). As with the vendor and end user users, enhancer user metrics are maintained (438), allowing system administrators to track enhancer activities within the system.

Although the innovative system disclosed and described herein involves management of food ingredient data, it is also adaptable for management of other types of data. For example, such novel features would be beneficial for use with agribusiness (chemical, feed, fertilizer, grain, herbicide, pesticide, seed, and other), beverage, bioremediation, cosmetic, chemical, electronics, industrial (dry and liquid compounds, and parts), nutraceutical, personal care, pet food, and pharmaceutical industries. Such additional uses are contemplated herein and are within the scope of the claims.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to: (a) information permanently stored on non-writeable storage media (e.g. read only memory devices within a computer such as ROMs or CD-ROM disks readable only by a computer I/O attachment); (b) information alterably stored on writeable storage media (e.g. floppy disks and hard drives); or (c) information conveyed to a computer through communication media, such as a local area network, a telephone network, or a public network like the Internet. It should be understood, therefore, that such media, when carrying computer readable instructions that direct the method functions of the present invention, may represent alternate embodiments of the present invention.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

I claim:

1. A cloud based system for managing ingredient data, the system comprising:
a network-accessible database device adapted to accept from a vendor through a vendor interface and retain within the database device at least one digital representation and a plurality of technical data for each of a plurality of items, the database device further adapted to accept from an end user through an end user interface an image related data for correlation with one of the at least one digital representations and present to the end user the technical data related to the correlated item; and
an image processor operable within the end user interface for converting a digital image data to the image related data for correlation with the at least one digital representation.

2. The system of claim 1, the system further comprising:
a vendor interface for a vendor computing device, the vendor interface adapted to access a computing device camera to obtain an image for use in generating the digital representation.

3. The system of claim 1, the system further comprising:
an end user interface for an end user computing device, the end user interface adapted to utilize the image processor to access a computing device camera to obtain a digital image data for use in generating the image related data.

4. The system of claim 1, wherein the database device is further adapted to accept enhancement data for each of the plurality of items, the system further comprising:
an enhancer interface for an enhancer computing device, the enhancer interface adapted to submit enhancement data for one or more of the plurality of items.

5. The system of claim 1, wherein the database device is further adapted to manage the digital representation and technical data stored therein through commands received from a vendor interface.

6. The system of claim 1, wherein the database device is further adapted to accept from an enhancer interface and retain within the database device a plurality of enhancement data for one or more of the plurality of items.

7. The system of claim 1, wherein the digital representation is chosen from the group consisting of linear code data, matrix code data, textual data, and image data.

8. The system of claim 1, wherein the image related data is generated based upon the action of a camera device.

9. The system of claim 1, wherein the database device is further adapted to track an update to an item or to the technical data associated with an item and to provide notification of the update to an end user that registered a previous interest in the item or the technical data associated with the item.

10. The system of claim 1, wherein the database device is further adapted to capture transactional data based on system use.

11. The system of claim 1, wherein the database device is further adapted to capture transactional data based on system use and to generate a configurable report based on the captured transactional data.

12. The system of claim 1, wherein the database device is further adapted to generate a linear code or matrix code for use with an item.

13. The system of claim 1, wherein the database device is further adapted to correlate the image related data with one digital representation, and to present to an end user the related technical data.

14. The system of claim 1, wherein the database device is further adapted to correlate the image related data with more than one digital representation, and to present to the end user the related technical data.

15. A cloud based method for managing ingredient data, the method steps comprising:
accepting from a vendor through a vendor interface, for retention within one or more database device tables, a plurality of technical data and at least one digital representation and for each of a plurality of items and retaining same within one or more database device tables for subsequent database operations thereon;
accepting from an end user through an end user interface an image related data representing an item of interest; and
correlating the image related data with a digital representation to determine the item of interest, and retrieving the related technical data from the database device for presentation of the technical data to the end user.

16. The method of claim 15, the method steps further comprising:
accepting an image from a vendor user computing device camera; and
generating the digital representation.

17. The method of claim 15, the method steps further comprising:
accepting an image from an end user computing device camera; and
generating the image related data.

18. The method of claim 15, the method steps further comprising:
accepting from an enhancer user through an enhancer interface, for retention within the database device tables, enhancement data related to one or more items.

19. The method of claim 15, wherein the digital representation is chosen from the group consisting of linear code data, matrix code data, textual data, and image data.

20. The method of claim 15, wherein the image related data is generated based upon the action of a camera device.

21. The method of claim 15, the method steps further comprising:
tracking an update to the item or the technical data associated with the item; and
providing notification of the update to an end user that registered a previous interest in the technical data or the related item.

22. The method of claim 15, the method steps further comprising:
capturing transactional data based on system use; and
generating a configurable use report based upon the captured transactional data.

23. The method of claim 15, the method steps further comprising:
generating a linear code or matrix code for use with an item.

24. The method of claim 15, the method steps further comprising:
correlating the image related data with one or more digital representations; and
presenting to the end user the related technical data.
